(19) United States
(12) Patent Application Publication
(10) Pub. No.: US 2023/0207167 A1
(43) Pub. Date: Jun. 29, 2023

(54) MAGNETIC PARTICLE AND MAGNETIC COMPONENT

(71) Applicant: SAMSUNG ELECTRO-MECHANICS CO., LTD., Suwon-si (KR)

(72) Inventors: Jong Ok JEON, Suwon-si (KR); Jeong Ho LIM, Suwon-si (KR); Hyo Ki HONG, Suwon-si (KR); Il Jin PARK, Suwon-si (KR); Young Seuck YOO, Suwon-si (KR); In Young KANG, Suwon-si (KR)

(73) Assignee: SAMSUNG ELECTRO-MECHANICS CO., LTD., Suwon-si (KR)

(21) Appl. No.: 18/071,199

(22) Filed: Nov. 29, 2022

(30) Foreign Application Priority Data
Dec. 28, 2021 (KR) 10-2021-0189222
Aug. 10, 2022 (KR) 10-2022-0099703

(51) Int. Cl. H01F 1/153; B22F 1/054; B22F 1/16

(52) U.S. Cl. CPC H01F 1/15333; B22F 1/054; B22F 1/16; B22F 2301/35; B22F 2302/25; B22F 2304/054; B22F 2304/056; B22F 2304/058; C22C 38/18

(57) ABSTRACT

A magnetic particle includes a magnetic metal particle, and an oxide film formed on a surface of the magnetic metal particle, wherein the magnetic metal particle includes a single crystalline zone containing an Fe component, and the oxide film includes an amorphous zone containing an Fe component. The single crystalline zone may include an α-Fe phase.

### CROSS-REFERENCE TO RELATED APPLICATION(S)

This application claims benefit of priority to Korean Patent Application No. 10-2021-0189222 filed on Dec. 28, 2021 and Korean Patent Application No. 10-2022-0099703 filed on Aug. 10, 2022 in the Korean Intellectual Property Office, the disclosures of which are incorporated herein by reference in their entireties.

### TECHNICAL FIELD

The present disclosure relates to a magnetic particle and a magnetic component.

In a magnetic component such as an inductor, a common mode filter, an LC filter, a balun, a magnetic recording medium, or the like, a magnetic particle is generally included in a body to realize the intended magnetic properties. In this case, the magnetic particle may be formed of a ferrite-based magnetic material, a metal-based magnetic material, or the like.

In a magnetic component, in order to realize low resistance, a high DC bias characteristic, a high efficiency characteristic, or the like, it is necessary to refine the magnetic particle and increase a filling rate of the magnetic particle while reducing loss thereof. However, in the trend of miniaturization of the magnetic component, a size of the body may be also being miniaturized, and accordingly, there may be a limit in increasing amounts of magnetic particles that may be included in the body. In addition, when the body is formed with a high pressure in order to increase the filling rate of the magnetic particle, there may be problems such as causing deformation of the magnetic component. Accordingly, there is a need for a method for minimizing loss of magnetic components by improving properties of the magnetic particle.

### SUMMARY

An aspect of the present disclosure is to realize a magnetic particle in which a loss characteristic of a magnetic component is improved.

As a method for solving the above problems, the present disclosure intends to propose a novel magnetic particle through an example, and specifically, the magnetic particle includes a magnetic metal particle, and an oxide film disposed on a surface of the magnetic metal particle, wherein the magnetic metal particle includes a single crystalline zone containing a first Fe component, and the oxide film includes an amorphous zone containing a second Fe component.

In an embodiment, the magnetic metal particle may consist of the single crystalline zone.

In an embodiment, the magnetic metal particle may be free of an amorphous zone.

In an embodiment, an area ratio of the single crystalline zone in a cross-section of the magnetic metal particle may be 30% or more.

In an embodiment, the single crystalline zone may include an Fe-Si-Cr-based alloy.

In an embodiment, the single crystalline zone may include an α-Fe phase.

In an embodiment, the α-Fe phase may include at least one selected from the group consisting of an Fe (001) phase, an Fe (002) phase, an Fe (011) phase, an Fe (101) phase, and an Fe (111) phase.

In an embodiment, the amorphous zone of the oxide film may include an Fe-based metal oxide.

In an embodiment, the oxide film may further include a crystalline zone.

In an embodiment, an area ratio of the amorphous zone in a cross-section of the oxide film may be 30% or more.

In an embodiment, a thickness of the oxide film may be 5 to 20 nm.

In an embodiment, the magnetic particle may have a diameter of 10 to 900 nm.

According to another aspect of the present disclosure, a magnetic component includes a body including a plurality of magnetic particles, wherein at least one magnetic particle, among the plurality of magnetic particles, includes a magnetic metal particle including a first Fe component and an oxide film disposed on a surface of the magnetic metal particle, and wherein the magnetic metal particle includes a single crystalline zone containing the first Fe component, and the oxide film includes an amorphous zone containing a second Fe component.

In an embodiment, the magnetic component may include a coil disposed in the body.

In an embodiment, the at least one magnetic particle including the single crystalline zone is referred to as a single crystal particle, a plurality of single crystal particles are present in the body, and D50 of a diameter of each of the plurality of single crystal particles is 100 to 300 nm.

According to another aspect of the present disclosure, a magnetic component includes a body including a plurality of magnetic particles, wherein the plurality of magnetic particles include first to third magnetic particles including first to third magnetic metal particles, respectively, wherein the first magnetic particle has a diameter in a first diameter range, the second magnetic particle has a diameter in a second diameter range, smaller than the first diameter range, and the third magnetic particle has a diameter in a third diameter range, smaller than the second diameter range, wherein the third magnetic metal particle includes a single crystalline zone containing a first Fe component.

In an embodiment, the diameters of the first to third magnetic particles may be diameters measured in a cross-section of the body.

In an embodiment, the first diameter range may be 5 to 61 μm, the second diameter range may be 0.6 to 4.5 μm, and the third diameter range may be 10 to 900 nm.

In an embodiment, the second and third magnetic metal particles may include different materials.

In an embodiment, in the cross-section of the body, relative to a sum of areas of the first to third magnetic particles, an area ratio of the first magnetic particle may be 50 to 90%, and an area ratio of the third magnetic particle may be 7.6 to 16%.

In an embodiment, the first diameter range may be 5 to 61 μm, the second diameter range may be 0.9 to 4.5 μm, and the third diameter range may be 10 to 800 nm.

In an embodiment, the first to third magnetic particle may further include first to third oxide films respectively disposed on surfaces of the first to third magnetic metal particles, wherein the third oxide film may include an amorphous zone including a second Fe component.

According to another aspect of the present disclosure, a composition includes a first magnetic particle having a diameter in a first diameter range, a second magnetic particle having a diameter in a second diameter range, smaller than the first diameter range, and a third magnetic particle having a diameter in a third diameter range, smaller than the second diameter range, the third magnetic particle including a third magnetic metal particle that includes a single crystalline zone containing a first Fe component and a third oxide film disposed on a surface of the third magnetic metal particle, the third oxide film including an amorphous zone including a second Fe component.

In an embodiment, the third magnetic metal particle may consist of the single crystalline zone.

In an embodiment, the single crystalline zone may include an Fe-Si-Cr-based alloy.

In an embodiment, the single crystalline zone may include an α-Fe phase.

In an embodiment, the α-Fe phase may include an Fe(011) phase.

In an embodiment, the composition may further include an insulating material including at least one of an epoxy resin, polyimide, and a liquid crystal polymer.

In an embodiment, the first magnetic particle may include a first magnetic metal particle and a first oxide film disposed on a surface of the first magnetic metal particle, the second magnetic particle may include a second magnetic metal particle and a second oxide film disposed on a surface of the second magnetic metal particle.

In an embodiment, the first to third magnetic metal particles may each independently include at least one of pure iron, an Fe-Si-based alloy, an Fe-Si-Al-based alloy, an Fe-Ni-based alloy, an Fe-Ni-Mo-based alloy, an Fe-Ni-Mo-Cu-based alloy, an Fe-Co-based alloy, an Fe-Ni-Co-based alloy, an Fe-Cr-based alloy, an Fe-Cr-Si-based alloy, an Fe-Si-Cu-Nb-based alloy, an Fe-Ni-Cr-based alloy, and an Fe-Cr-Al-based alloy.

In an embodiment, the first to third oxide films may each independently include Fe₂O₃, Fe₃O₄ or both.

According to another aspect of the present disclosure, a magnetic component including a body including first to third magnetic particles, the first magnetic particle having a diameter in a first diameter range, the second magnetic particle having a diameter in a second diameter range, smaller than the first diameter range, and the third magnetic particle having a diameter in a third diameter range, smaller than the second diameter range, the third magnetic particle including a third magnetic metal particle that includes a single crystalline zone containing a first Fe component and a third oxide film disposed on a surface of the third magnetic metal particle, the third oxide film including an amorphous zone including a second Fe component.

In an embodiment, the body may include a laminate including a plurality of layers including the first to third magnetic particles.

In an embodiment, in a cross-section of the body, relative to a sum of areas of the first to third magnetic particles, an area ratio of the first magnetic particle may be 50 to 90%, and an area ratio of the third magnetic particle may be 7.6 to 16%.

In an embodiment, the magnetic component may further include a coil disposed within the body, a support member supporting the coil, a through-hole is disposed in a central portion of the support member, and an external electrode disposed on a surface of the body to be electrically connected to the coil.

In an embodiment, the magnetic component may further include a coil portion embedded in the body, an external electrode disposed on a surface of the body to be electrically connected to the coil portion, wherein the body includes a mold portion including a core that passes through the coil portion.

In an embodiment, the body may further include a cover portion disposed on the mold portion, and the cover portion may surround all surfaces of the mold portion except for a lower surface of the mold portion.

In an embodiment, the magnetic component may further include an accommodating groove disposed in the mold portion.

In an embodiment, the coil portion may include an end portion disposed in the accommodating groove.

### BRIEF DESCRIPTION OF DRAWINGS

The above and other aspects, features, and advantages of the present disclosure will be more clearly understood from the following detailed description, taken in conjunction with the accompanying drawings, in which:

FIGS. 1A and 1B illustrate a magnetic particle according to an embodiment of the present disclosure. FIGS. 1A and 1B correspond to a transmission perspective view and a cross-sectional view, respectively.

FIGS. 2 and 3 illustrate magnetic particles according to modified embodiments.

FIGS. 4 to 8 illustrate results of HR-TEM analysis of magnetic metal particles.

FIG. 9 is a schematic transparent perspective view illustrating a magnetic component according to an embodiment of the present disclosure.

FIG. 10 is a schematic cross-sectional view of the magnetic component of FIG. 9, taken along line I-I′.

FIGS. 11 and 12 are enlarged views of a region of a body in the magnetic component of FIG. 9.

FIG. 13 illustrates the magnetic particles illustrated in FIG. 12.

FIGS. 14 to 18 illustrate a magnetic component having a wound coil structure.

### DETAILED DESCRIPTION

Hereinafter, embodiments of the present disclosure will be described with reference to specific embodiments and the accompanying drawings. Embodiments of the present disclosure may be modified in various other forms, and the scope of the present disclosure is not limited to embodiments described below. Further, embodiments of the present disclosure may be provided in order to more completely explain the present disclosure to those skilled in the art. Accordingly, shapes and sizes of components in the drawings may be exaggerated for clearer description, and components indicated by the same reference numerals in the drawings may be the same elements.

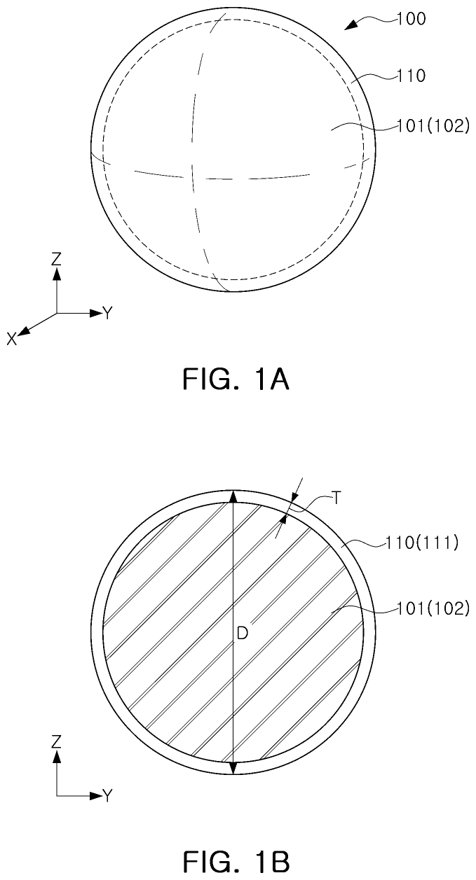

FIGS. 1A and 1B illustrate a magnetic particle according to an embodiment of the present disclosure. FIGS. 1A and 1B correspond to a transmission perspective view and a cross-sectional view, respectively. In the present embodiment, a magnetic particle 100 may include a magnetic metal particle 101 and an oxide film 110 formed on a surface thereof. In this case, the magnetic metal particle 101 may include a single crystalline zone 102 containing a first Fe component, and the oxide film 110 may include an amorphous zone containing a second Fe component. As will be described later, coercive force of the magnetic particle 100 may be lowered by implementing a crystal characteristic of the magnetic metal particle 101 and a crystal characteristic of the oxide film 110, constituting the magnetic particle 100, as in the present embodiment. When the magnetic particle 100 is used for a magnetic component, an efficiency characteristic may be improved by lowering loss thereof.

The magnetic metal particle 101 may include a material for securing magnetic properties, for example, a metal including iron (Fe), silicon (Si) and chromium (Cr). More specifically, the magnetic metal particle 101 may include at least one selected from the group consisting of iron (Fe), silicon (Si), chromium (Cr), cobalt (Co), molybdenum (Mo), aluminum (Al), niobium (Nb), copper (Cu), and nickel (Ni). Specifically, the magnetic metal particle 101 may include at least one of pure iron, an Fe-Si-based alloy, an Fe-Si-Al-based alloy, an Fe-Ni-based alloy, an Fe-Ni-Mo-based alloy, an Fe-Ni-Mo-Cu-based alloy, an Fe-Co-based alloy, an Fe-Ni-Co-based alloy, an Fe-Cr-based alloy, an Fe-Cr-Si-based alloy, an Fe-Si-Cu-Nb-based alloy, an Fe-Ni-Cr-based alloy, and an Fe-Cr-Al-based alloy. As described above, the magnetic metal particle 101 may include the single crystalline zone 102, and the single crystalline zone 102 may include an Fe-Si-Cr-based alloy. In this case, Si and Cr in the Fe-Si-Cr-based alloy may be 15wt % or less, and as a more specific example, 0.80wt %<Si<12.5wt %, 2.5wt %<Cr<14.2wt %.

The single crystalline zone 102 may include an α-Fe phase, and in this case, the α-Fe phase may include at least one of the group consisting of an Fe(001) phase, an Fe(002) phase, an Fe(011) phase, an Fe(101) phase, and an Fe(111) phase. The single crystalline zone 102 may be defined as a region in which a crystal present therein is formed to have a constant orientation. For example, when the single crystalline zone 102 is comprised of an Fe (011) phase, a different Fe phase, an Fe oxide phase (e.g., an Fe₃O₄ phase), or the like, present in the magnetic metal particle 101, may not be included in the single crystalline zone 102, and may form a polycrystalline structure. As can be seen from those illustrated, the magnetic metal particle 101 may be formed of one single crystalline zone 102. In addition, the magnetic metal particle 101 may not include an amorphous zone, other than the single crystalline zone 102. As in a modified embodiment of FIG. 2, the magnetic metal particle 101 may further include an amorphous zone 103 in addition to the single crystalline zone 102. When the single crystalline zone 102 and the amorphous zone 103 are present in the magnetic metal particle 101, an area ratio of the single crystalline zone 102 in a cross-section of the magnetic metal particle 101 may be 30% or more, based on a total area of the magnetic metal particle 101 in a cross-section of the magnetic metal particle 101. The cross-section of the magnetic metal particle 101 may be a cross-section including a center thereof or taken in a plurality of regions at equal intervals, observed with an electron microscope, and the area ratio may be obtained using an image analysis program. Other methods and/or tools appreciated by one of ordinary skill in the art, even if not described in the present disclosure, may also be used. Also, a sum of an area of the single crystalline zone 102 and an area of the amorphous zone 103 may be 50% or more, based on a total area of the magnetic metal particle 101 in a cross-section of the magnetic metal particle 101.

As described above, when the magnetic metal particle 101 is substantially comprised of the single crystalline zone 102, coercive force may be lower than that in a case having a polycrystalline structure. In particular, when the magnetic metal particle 101 is an ultrafine particle having a relatively small size, it may be difficult to have an amorphous form, and, thus, it may be difficult to sufficiently lower coercive force. As in the present embodiment, the magnetic metal particle 101 may be implemented with a single crystalline structure to significantly reduce coercive force. When the magnetic particle 100 having reduced coercive force is used, a Q efficiency characteristic and a loss characteristic of the magnetic component may be improved.

A size of the magnetic particle 100, corresponding to an ultrafine particles, may have a diameter D of 10 to 900 nm. The diameter D of the magnetic particle 100 may mean an average value of diameters of a particle measured in a cross-section in the center thereof. For example, a Z-Y plane passing through a center of the magnetic particle 100 may be photographed with a scanning electron microscope (SEM).

Other methods and/or tools appreciated by one of ordinary skill in the art, even if not described in the present disclosure, may also be used. In addition, as a specific example, in an SEM image, an image pixel size may be fixed to be 10 nm by 10 nm and a working distance may be fixed to be 8 mm. In addition, a back scattered mode may be used. Thereafter, a diameter D may be calculated using an image analysis program (e.g., ORS's deep learning tool). The magnetic particle 100 may have a spherical shape or a substantially spherical shape, but the present disclosure is not limited thereto. Therefore, when the magnetic particle 100 has an arbitrary shape that does not maintain a spherical shape, the above-mentioned diameter may be interpreted as being replaced with a Feret diameter, and an average value of the diameter may be also replaced with an average value of the Feret diameter. As a method of calculating the average value of the diameter, a tool of the image processing software may be used, and size distribution may be obtained by particle size analysis for each area. However, the aforementioned method is one of examples to analyze a size of the magnetic particle 100 individually, and as explained below, when analyzing sizes of magnetic particles included in magnetic components 200, 400 and 500, those sizes can be obtained by an image of a cross-section of the magnetic components 200, 400 and 500.

The oxide film 110 may be formed on a surface of the magnetic metal particle 101, to protect the magnetic metal particle 101 and to have the magnetic metal particle 101 electrically insulated from the outside. Loss of eddy current of the magnetic particle 100 may be reduced by the oxide film 110. As described above, the oxide film 110 may include an amorphous zone 111 containing a second Fe component. In this case, the amorphous zone 111 may include an Fe-based metal oxide, such as an oxide of a metal including Fe, Si, Cr or the like. The amorphous zone 111 does not substantially have an internal structure of a crystalline structure, and as in the present embodiment, the oxide film 110 may be substantially comprised of the amorphous zone 111. As in a modified embodiment of FIG. 3, the oxide film 110 may include a crystalline zone 112 in addition to the amorphous zone 111.

The crystalline zone 112 may include an Fe₃O₄ component. In this case, an area ratio of the amorphous zone 111 in a cross-section of the oxide film 110 may be 30% or more, based on a total area of the oxide film 110 in a cross-section of the oxide film 110. The cross-section of the oxide film 110 may be taken from a plurality of regions at equal intervals. And, a thickness T of the oxide film 110 may be 5 to 20 nm. The area ratio of the amorphous zone 111 and the thickness T may be measured using methods disclosed herein. Other methods and/or tools appreciated by one of ordinary skill in the art, even if not described in the present disclosure, may also be used.

In an example of a manufacturing method for making the magnetic metal particle 101 have the single crystalline zone 102, a raw material may be evaporated using an RF plasma process, and then cooled using an inert gas, to form a fine powder. In this process, the polycrystalline structure of the raw material may be changed to a single crystalline structure. In this case, a process of separating a powder having a large particle size may be performed by moving an obtained powder through an airflow, or the like. In this case, the RF plasma process may be performed in a reducing atmosphere (e.g., an H₂ gas atmosphere), and in this process, the oxide film 110 having the amorphous zone 111 may be formed on a surface of the magnetic metal particle 101. The amorphous zone 111 of the oxide film 110 has a possibility of lowering magnetism, as compared to the crystalline form, but a super-paramagnetism characteristic may be implemented to magnetize the magnetic metal particle 101. In this case, the above may be higher than magnetic susceptibility of a general paramagnetic material. When the magnetic metal particle 101 is formed to have a polycrystalline structure, since they may be produced in a general N₂ gas atmosphere, the magnetic metal particle 101 may have an angular facet, and thus the oxide film 110 may be grown as facet growth, to form a crystalline oxide film.

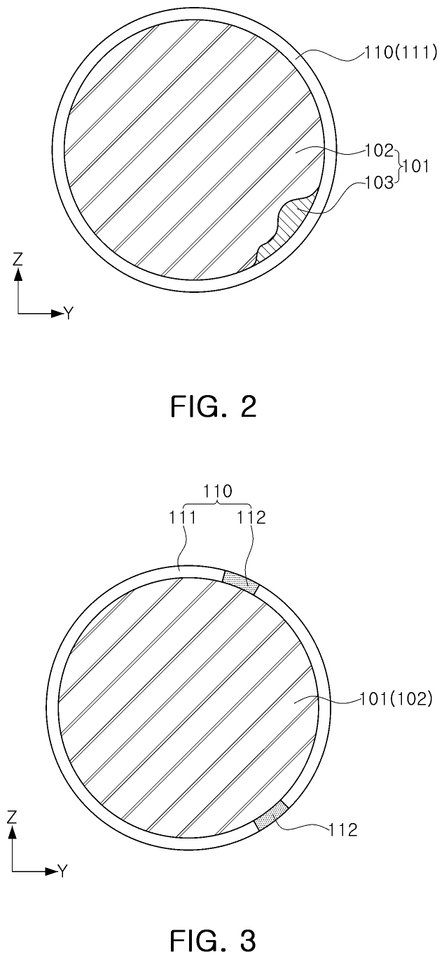

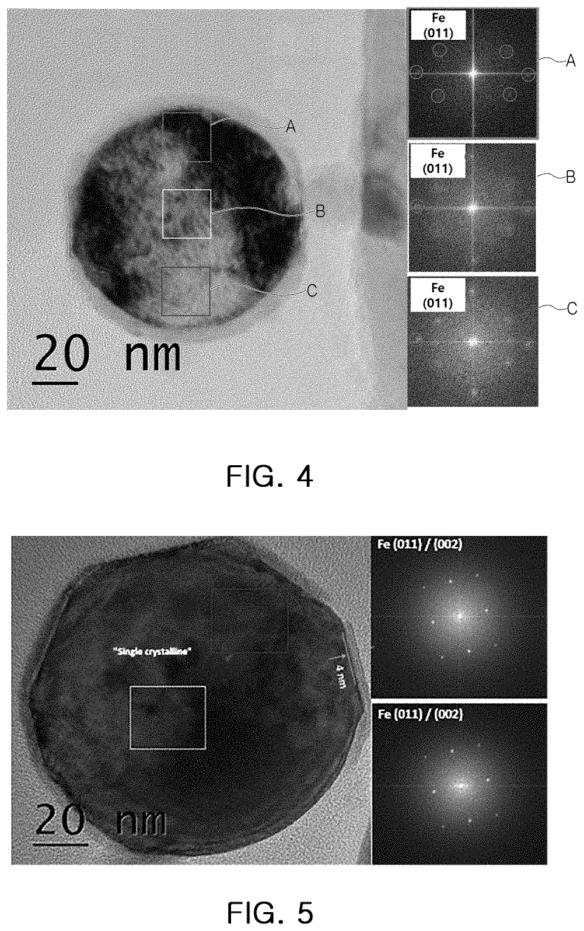

The inventors of the present disclosure have prepared a magnetic particle having a single crystalline zone, based on the above description, and have analyzed the cross-section. FIGS. 4 to 8 illustrate results of HR-TEM analysis of magnetic metal particles. In this case, samples prepared for HR-TEM analysis were pretreated with a focused ion beam (FIB). And, for HR-TEM, JEOL 2100F was used. First, it was confirmed that prepared magnetic particles had a diameter range of 10 to 900 nm, and in a component, which is a magnetic metal particle, Fe was mostly occupied, and Si and Cr were added. And, as a result of STEM-EDS analysis of the magnetic metal particle, it was confirmed that Fe—Si—Cr exhibited a uniform component distribution therein. In addition, in an oxide film covering the magnetic metal particle, a thickness was formed in the range of 5 to 20 nm.

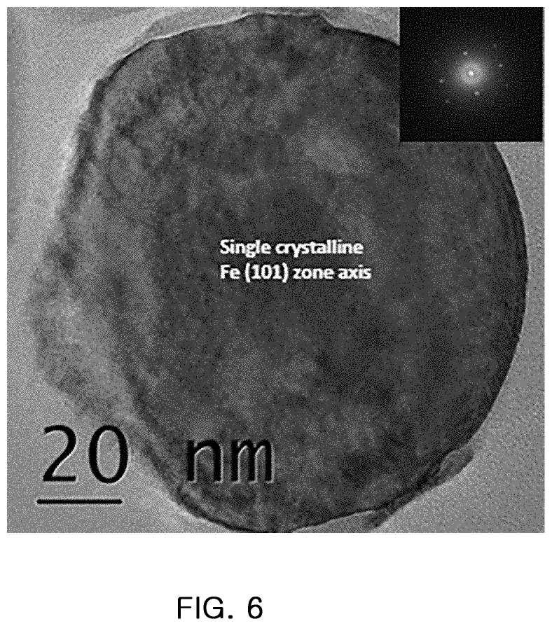

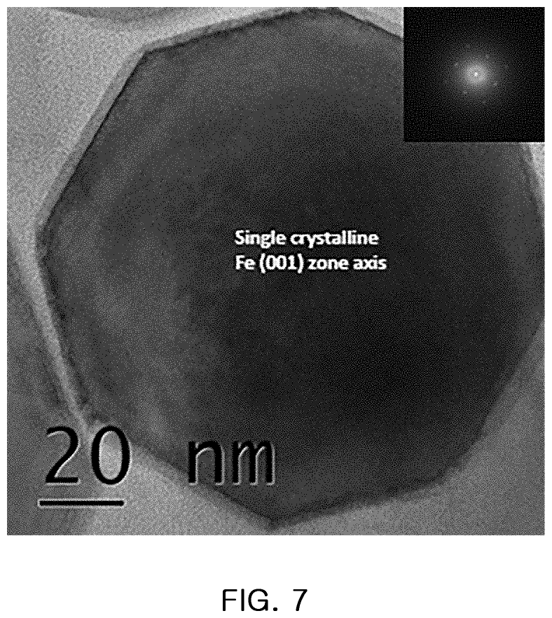

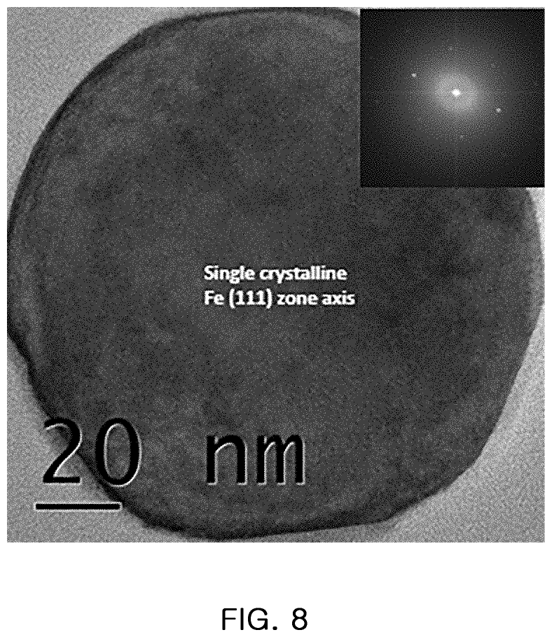

Referring to FIG. 4, as a result of analyzing an orientation of a cross-sectional image of a magnetic metal particle, it was confirmed that a single crystalline zone having one orientation angle was formed, and in this case, a main peak of the single crystalline zone containing Fe was (011). In this case, in the orientation analysis, fast Fourier transform (FFT) analysis was performed on the cross-sectional image using software (e.g., a Gatan digital microscopy), and it was confirmed that all analyzed regions were the single crystalline zone oriented with Fe (011), as can be seen from the analysis result illustrated on the right side of FIG. 4. In addition, it was also confirmed that the single crystalline zone containing Fe had a different orientation angle. FIG. 5 illustrates that a single crystalline zone oriented with Fe (011) and Fe (002) was included, FIG. 6 illustrates that a single crystalline zone oriented with Fe (101) was included, FIG. 7 illustrates that a single crystalline zone oriented with Fe (001) was included, and FIG. 8 illustrates that a single crystalline zone oriented with Fe (111) was included.

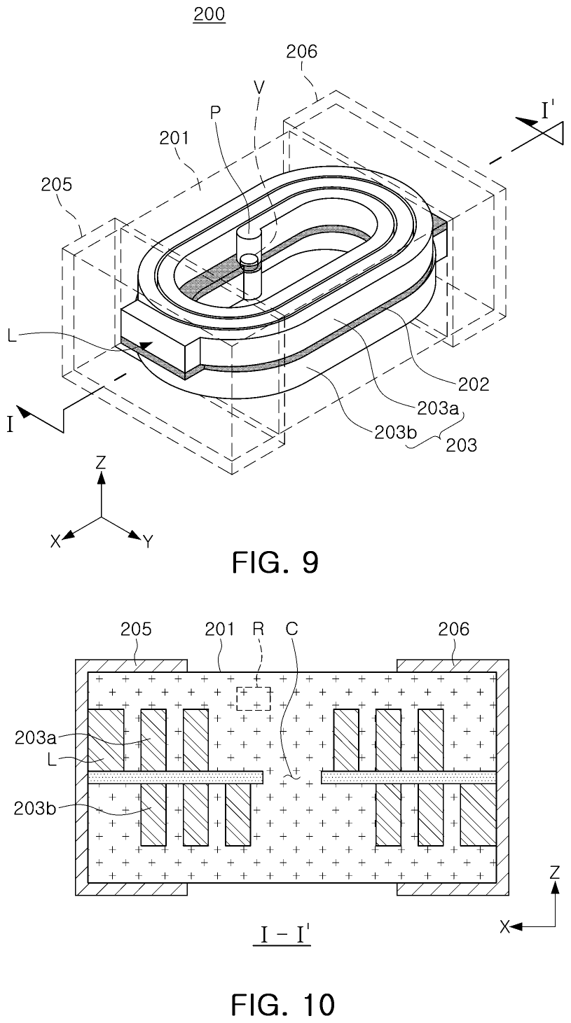

Hereinafter, an example of a magnetic component including the above-described magnetic particle will be described. Referring to FIGS. 9 to 11, in the present embodiment, a magnetic component 200 including a plurality of magnetic particles 211 corresponds to a coil component. Specifically, the magnetic component 200 may include a body 201, a support member 202, a coil 203, and external electrodes 205 and 206, and the body 201 may include a plurality of magnetic particles 211. In this case, at least one magnetic particle, among the plurality of magnetic particles 211, may have the above-described single crystalline structure, and specifically, may include a magnetic metal particle 101 including an Fe component (a first Fe component) and an oxide film 110 formed on a surface thereof, where the magnetic metal particle 101 may include a single crystalline zone 102 containing the first Fe component. In addition, as described above, the oxide film 110 may include an amorphous zone including an Fe component (a second Fe component).

The body 201 may seal at least a portion of the support member 202 and at least a portion of the coil 203, to form an exterior of the magnetic component 200. Also, the body 201 may be formed such that a partial region of a lead-out pattern L is exposed externally. As illustrated in FIG. 10, the body 201 may include a plurality of magnetic particles 211, and the magnetic particles 211 may be dispersed in an insulating material 210. The insulating material 210 may include a polymer component such as an epoxy resin, polyimide, or the like. The body 201 may include a plurality of magnetic particles 211, and at least one magnetic particle, among the plurality of magnetic particles 211, may have a single crystalline structure (or a substantially single crystalline structure), as described with reference to FIGS. 1 to 4. As described above, coercive force of a magnetic particle 211 in which a magnetic metal particle 101 has a single crystalline zone 102 containing an Fe component (a first component), and an oxide film 110 has an amorphous zone 111 containing an Fe component (a second component), may be reduced, and in a magnetic component 200 using the same, a Q characteristic and a loss characteristic may be improved. If a magnetic particle 211 including the above-described single crystalline zone 102, among the magnetic particles 211, is referred to as a single crystal particle 211, the single crystal particle 211 may be included as a plurality of single crystal particles 211 in the body 201, and the plurality of single crystal particles 211 may have D50 of a diameter of 100 to 300 nm, respectively. In this case, D50 means a value located at a center when arranging in the order of diameter size. D50 may be determined from the methods and/or tools disclosed herein. Other methods and/or tools appreciated by one of ordinary skill in the art, even if not described in the present disclosure, may also be used.

A diameter of the magnetic particle 211 present in the body 201 may be measured in a cross-section of the body 201. Specifically, with respect to a cross-section in X-Z directions passing through a center of the body 201, a plurality of regions (e.g., five (5) or ten (10) regions) at equal intervals in a Y-direction may be photographed with a scanning electron microscope, and then a diameter of the magnetic particle 211 may be obtained using an image analysis program. In this case, since the magnetic particle 211 may be deformed or the oxide film 110 may be destroyed in an outer region of the body 201 by a compression process, the diameter of the magnetic particle 211 may be measured except for this. For example, a region corresponding to a length within 5% or 10% from a surface of the body 201 may be excluded.

In relation to an example of a manufacturing method, the body 201 may be formed by a lamination method. Specifically, after forming the coil 203 on the support member 202 using a method such as plating or the like, a unit stack for manufacturing the body 201 may be prepared as a plurality of unit stacks, and a plurality of unit stacks may be stacked. In this case, the unit stack may be prepared by mixing the magnetic particle 211 such as a metal or the like, and an organic material such as a thermosetting resin, a binder, a solvent, or the like, to prepare a slurry, and applying and drying the slurry to a carrier film by a doctor blade method by a thickness of several tens of pm, to have a sheet type. Therefore, the unit stack may be prepared in a manner in which magnetic particles are dispersed in a thermosetting resin such as an epoxy resin, polyimide, or the like. The body 201 may be implemented by forming a plurality of the above-described unit stacks, and pressing and stacking them in upward and downward directions based on the coil 203.

The support member 202 may support the coil 203, and may be formed of a polypropylene glycol (PPG) substrate, a ferrite substrate, a metal-based soft magnetic substrate, or the like. As illustrated, a central portion of the support member 202 may be penetrated to form a through-hole, and a portion of the body 201 may be filled in the through-hole to form the magnetic core portion C.

The coil 203 may be mounted into the body 201, and may serve to perform various functions in an electronic device due to characteristics expressed from the coil of the magnetic component 200. For example, the magnetic component 200 may be a power inductor, and in this case, the coil 203 may play a role for storing electricity as a magnetic field to maintain an output voltage, to stabilize power, or the like. In this case, a coil pattern constituting the coil 203 may include a first coil 203a and a second coil 203b, as stacked on both sides of the support member 202, respectively, and the first coil 203a and the second coil 203b may be electrically connected to each other through a conductive via V passing through the support member 202. In this case, the coil 203 may include a pad region P. The coil 203 may be formed to have a spiral shape. In an outermost portion of the spiral shape, a lead-out portion T exposed to the outside of the body 201 for electrical connection with the external electrodes 205 and 206 may be included. Unlike those illustrated, the coil 203 may be disposed on only one surface of the support member 202. The coil pattern constituting the coil 203 may be formed using a plating process used in the art, such as pattern plating, anisotropic plating, isotropic plating, or the like, a plurality of processes among these processes may be used to have a multilayer structure. The coil 203 may be implemented as a winding type coil structure, and in this case, the support member 202 may not be included in the body 201. The winding-type coil structure will be described in detail in embodiments below with reference to

The external electrodes 205 and 206 may be formed outside the body 201, to be connected to the lead-out portion T. The external electrodes 205 and 206 may be formed using a paste containing a metal having excellent electrical conductivity, and the paste may be, for example, a conductive paste containing nickel (Ni), copper (Cu), tin (Sn), silver (Ag), or the like, alone, or alloys thereof. In addition, a plating layer may be further formed on the external electrodes 205 and 206. In this case, the plating layer may include any one or more selected from the group consisting of nickel (Ni), copper (Cu), and tin (Sn), and, for example, a nickel (Ni) layer and a tin (Sn) layer may be formed sequentially.

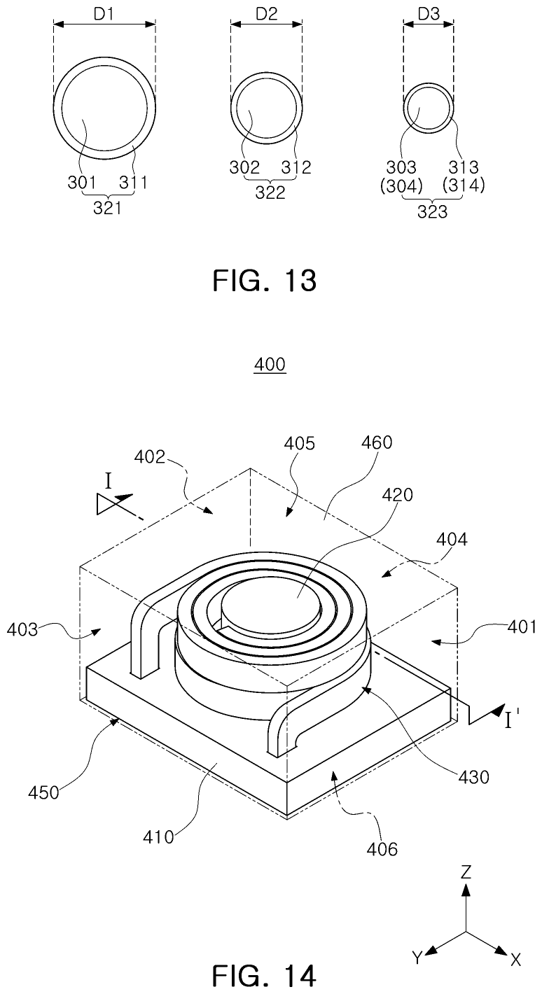

A magnetic component according to another embodiment will be described with reference to FIGS. 12 and 13. An embodiment of FIGS. 12 and 13 may be different from the embodiment of FIGS. 9 to 11 in view that a magnetic particle is present in a body. Since other components may be equally employed, a redundant description will be omitted. In the present embodiment, the body 201 may include a plurality of magnetic particles 321, 322, and 323, and the plurality of magnetic particles 321, 322, and 323 may include first to third magnetic particles 321, 322, and 323 respectively including first to third magnetic metal particles 301, 302 and 303. In this case, the plurality of magnetic particles 321, 322, and 323 may have different diameter sizes. Specifically, the first magnetic particle 321 may have a diameter D1 in a first diameter range, the second magnetic particle 322 may have a diameter D2 in a second diameter range, smaller than the first diameter range, and the third magnetic powder 323 may have a diameter D3 in the third diameter range, smaller than the second diameter range. As a specific example, the first diameter range may be 5 to 61 μm, and the second diameter range may be 0.6 to 4.5 μm. Also, the third diameter range may be 10 to 900 nm. The diameters of the first to third magnetic particles 321, 322, and 323 may be diameters measured in a cross-section of the body 201 using the methods and/or tools disclosed herein. Other methods and/or tools appreciated by one of ordinary skill in the art, even if not described in the present disclosure, may also be used. In the present embodiment, the third magnetic particle 323 having the smallest size may have a single crystalline structure, e.g., a structure including a single crystalline zone 304 containing an Fe component, such that coercive force is reduced, and thus a Q characteristic and a loss characteristic may be improved. The second magnetic particle 322 and the third magnetic particle 323 may partially overlap in diameter ranges. In this case, the second and third magnetic metal particles 302 and 303 may include different materials. Therefore, the second magnetic particle 322 and the third magnetic particle 323 may be distinguished by using a method such as SEM-EDS, XRF, or the like. In addition, to more clearly distinguish the first and third magnetic particles 321, 322, and 323, the first to third diameter ranges may not overlap each other, and, for example, the first diameter range may be 5 to 61 μm, the second diameter range may be 0.9 to 4.5 μm, and the third diameter range may be 10 to 800 nm.

As in the present embodiment, a plurality of types of magnetic particles 321, 322, and 323, having different sizes from each other, may be used to improve filling rates of the magnetic particles 321, 322, and 323 in the body 201, and from this, a magnetic characteristic of the magnetic component 200 may be improved. In addition, in an ultrafine powder having a relatively small size, it may be difficult to have an amorphous form, and, thus, it may be difficult to sufficiently lower coercive force.

The first to third magnetic metal particles 301, 302, and 303 may be at least one of pure iron, an Fe-Si-based alloy, an Fe-Si-Al-based alloy, an Fe-Ni-based alloy, an Fe-Ni-Mo-based alloy, an Fe-Ni-Mo-Cu-based alloy, an Fe-Co-based alloy, an Fe-Ni-Co-based alloy, an Fe-Cr-based alloy, an Fe-Cr-Si-based alloy, an Fe-Si-Cu-Nb-based alloy, an Fe-Ni-Cr-based alloy, and an Fe-Cr-Al-based alloy. The first magnetic particle 321 may include a first oxide film 311 formed on a surface of a first magnetic metal particle 301. Similarly, the second magnetic particle 322 may include a second oxide film 312 formed on a surface of a second magnetic metal particle 302, and the third magnetic particle 323 may include a third oxide film 313 formed on a surface of a third magnetic metal particle 303. The first to third oxide films 311, 312, and 313 may include an Fe oxide, for example, Fe₂O₃, Fe₃O₄, or the like. In addition, the first to third oxide films 311, 312, and 313 may include phosphate, ferrite (e.g., NiZnCu ferrite, NiZn ferrite), or the like.

In addition, an oxide such as MgO, Al₂O₃, or the like may be included. In this case, when the third magnetic metal particle 303 have a single crystalline structure, the third oxide film 313 may include an amorphous zone 314 containing an Fe component (a second component).

The inventors of the present disclosure have experimented with a change in characteristics (magnetic permeability, core loss, or the like) according to relative amounts of the first to third magnetic particles 321, 322, and 323, present in the body 201, and results therefrom are illustrated in Tables 1 to 3. As described above, diameters of the magnetic particles 321, 322, and 323, present in the body 201, may be measured in a cross-section of the body 201. Specifically, with respect to a cross-section in the X-Z directions passing through a center of the body 201, a plurality of regions (e.g., five (5) or ten (10) regions) at equal intervals in the Y-direction may be imaged with a scanning electron microscope, and then a diameter of the magnetic particles 321, 322, and/or 323 may be obtained using an image analysis program In addition, as a specific example, in an SEM image, an image pixel size may be fixed to be 10 nm by 10 nm and a working distance may be fixed to be 8 mm. In addition, a back scattered mode may be used. Thereafter, a diameter D may be calculated using an image analysis program (e.g., ORS's deep learning tool). The magnetic particles 321, 322 and 323 may have a spherical shape or a substantially spherical shape, but the present disclosure is not limited thereto. Therefore, when the magnetic particles 321, 322 and 323 have an arbitrary shape that does not maintain a spherical shape, the above-mentioned diameter may be interpreted as being replaced with a Feret diameter, and an average value of the diameter may be also replaced with an average value of the Feret diameter. As a method of calculating the average value of the diameter, a tool of the image processing software may be used, and size distribution may be obtained by particle size analysis for each area. In the meantime, if the magnetic particles 321, 322, and 323 may be deformed or the oxide film 110 may be destroyed in an outer region of the body 201 by a compression process, or the like, the magnetic particles 321, 322, and 323 may be excluded in the measurement, and, for example, a region corresponding to a length within 5% or 10% from a surface of the body 201 may be excluded. In addition, as another example, it is possible to infer a size of the destroyed particle through a size measured at three (3) points where destruction does not occur. Moreover, despite the aforementioned explanations, only one cross-section (i.e. a X-Y plane including the center of the magnetic component) may be used to obtain sizes of the magnetic particles 321, 322 and 323.

According to a measured diameter, a magnetic particle may be classified as a first magnetic particle 321 when a diameter range thereof is 5 to 61 μm, as a second magnetic particle 322 when a diameter range thereof is 0.6 to 4.5 μm, or as a third magnetic particle 323 when a diameter range thereof is 10 to 900 nm. And, an area ratio of each of the first to third magnetic particles relative to a sum of areas of the first to third magnetic particles for each sample was expressed as a percentage, and magnetic permeability and core loss were measured. The area ratio of each of the first to third magnetic particles may be measured in a cross-section of the body using a scanning electron microscope (SEM) and an image analysis program. Other methods and/or tools appreciated by one of ordinary skill in the art, even if not described in the present disclosure, may also be used.

First, Table 1 below illustrates results for samples having a D50 of the first magnetic particle of 21 to 36 μm, and samples 1, 2, and 9 marked with * correspond to comparative examples. In magnetic permeability, a case in which it increased by 5% or more increases, as compared to a reference sample, was indicated by “O,” and a case in which it did not increase by 5% was indicated by “X.” In this case, in the reference sample, a ratio of amounts of the first and second magnetic particles was 76:24, and the third magnetic particle was not included. Moreover, in core loss/Q, it was marked as bad (X) when Q decreased by 30% or more in the magnetic permeability increased, as compared to the reference sample (e.g., as bad when Q decreased by 6.5 or more when the magnetic permeability increased by 5).

TABLE 1

| | Area Ratio (%) | | | | |
|---|---|---|---|---|---|
| | First | Second | Third | | |
| | Magnetic | Magnetic | Magnetic | Magnetic | Core |
| Sample | Particle | Particle | Particle | Permeability | Loss/Q |
| 1* | 100 | 0 | 0 | X | X |
| 2* | 76 | 4 | 20 | X | X |
| 3 | 76 | 9 | 15 | ◯ | ◯ |
| 4 | 76 | 10.6 | 13.4 | ◯ | ◯ |
| 5 | 76 | 12 | 12 | ◯ | ◯ |
| 6 | 76 | 13.5 | 10.5 | ◯ | ◯ |
| 7 | 76 | 15 | 9 | ◯ | ◯ |
| 8 | 76 | 16.4 | 7.6 | ◯ | ◯ |
| 9* | 76 | 20 | 4 | X | ◯ |

Table 2 below illustrates results for samples having D50 of the first magnetic particle of 12 to 21 μm, and samples 10, 17, and 18 marked with * correspond to comparative examples.

TABLE 2

| | Area Ratio (%) | | | | |
|---|---|---|---|---|---|
| | First | Second | Third | | |
| | Magnetic | Magnetic | Magnetic | Magnetic | Core |
| Sample | Particle | Particle | Particle | Permeability | Loss/Q |
| 10* | 76 | 6.5 | 17.5 | X | X |
| 11 | 76 | 9 | 15 | ◯ | ◯ |
| 12 | 76 | 11 | 13 | ◯ | ◯ |
| 13 | 76 | 12 | 12 | ◯ | ◯ |
| 14 | 76 | 13 | 11 | ◯ | ◯ |
| 15 | 76 | 14.8 | 9.2 | ◯ | ◯ |
| 16 | 76 | 16.2 | 7.8 | ◯ | ◯ |
| 17* | 76 | 17 | 7 | X | X |
| 18* | 72 | 10 | 18 | X | X |
| 19 | 72 | 12 | 16 | ◯ | ◯ |
| 20 | 72 | 14 | 14 | ◯ | ◯ |

Table 3 below illustrates results for samples having D50 of the first magnetic particle of 5 to 12 μm, and samples 21 and 31 marked with * correspond to comparative examples.

TABLE 3

| | Area Ratio (%) | | | | |
|---|---|---|---|---|---|
| | First | Second | Third | | |
| | Magnetic | Magnetic | Magnetic | Magnetic | Core |
| Sample | Particle | Particle | Particle | Permeability | Loss/Q |
| 21* | 64 | 18 | 18 | ◯ | X |
| 22 | 64 | 20 | 16 | ◯ | ◯ |
| 23 | 64 | 22 | 14 | ◯ | ◯ |
| 24 | 64 | 24 | 12 | ◯ | ◯ |
| 25 | 64 | 26 | 10 | ◯ | ◯ |
| 26 | 68 | 16 | 16 | ◯ | ◯ |
| 27 | 72 | 14 | 14 | ◯ | ◯ |
| 28 | 72 | 16 | 12 | ◯ | ◯ |
| 29 | 76 | 12 | 12 | ◯ | ◯ |
| 30 | 76 | 16 | 8 | ◯ | ◯ |
| 31* | 76 | 20 | 4 | X | ◯ |

An optimized ratio of the first to third magnetic particles may be derived according to the above experimental results. Specifically, an area ratio of the first magnetic particle may be 90% or less, and an area ratio of the third magnetic particle may be 7.6 to 16%. In this case, it can be confirmed that good performance is illustrated in terms of magnetic permeability and core loss characteristics. In this case, when a ratio of the first magnetic particle having a relatively large size is lowered to less than half, a problem in which an overall filling rate of the magnetic particle is lowered to increase magnetic permeability loss may occur. Therefore, the area ratio of the first magnetic particle is preferably 50% or more.

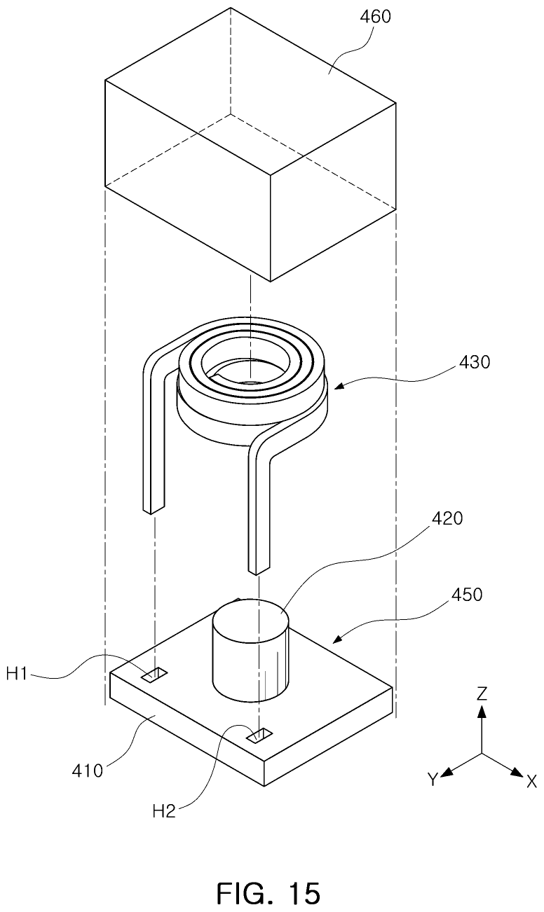

Hereinafter, a magnetic component having a wound coil structure as another type of magnetic component including the above-described magnetic particle will be described. First, referring to FIGS. 14 to 16, a magnetic component 400 may include a mold portion 450, a coil portion 430, a cover portion 460, and accommodating grooves h1 and h2, and may further include external electrode 470 and 480. A body B may form an exterior of the magnetic component 400, and the coil portion 430 may be embedded therein. The body B may include the mold portion 450 and the cover portion 460. The mold portion 450 may include a core 420. The body B may be formed to have a hexahedral shape as a whole. The body B may include a first surface 401 and a second surface 402, opposing each other in a first direction X, a third surface 403 and a fourth surface 404, opposing each other in a second direction Y, a fifth surface 405 and a sixth surface 406, opposing in the third direction Z. Each of the first to fourth surfaces 401, 402, 403, and 404 of the body B may correspond to a wall surface of the body B, connecting the fifth surface 405 and the sixth surface 406 of the body B. Hereinafter, both end surfaces of the body B mean the first surface 401 and the second surface 402 of the body B, and both side surfaces of the body B mean the third surface 403 and the fourth surface 404 of the body B.

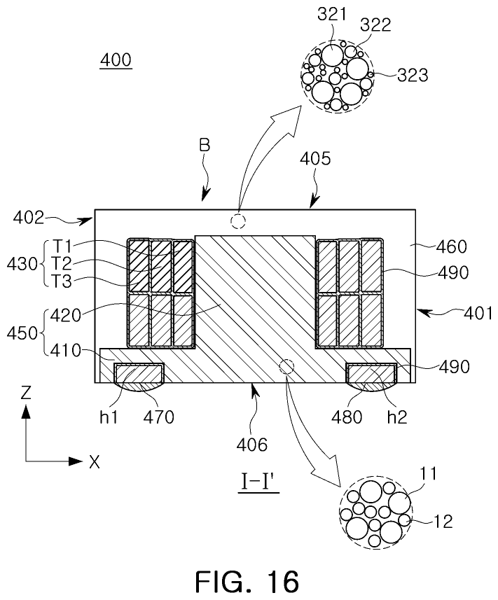

A body B may be formed, but is illustrative, such that a magnetic component 400 according to the present embodiment in which external electrodes 470 and 480 to be described later are formed has a length of 2.0 mm, a width of 1.2 mm, and a thickness of 0.6 mm, but the present disclosure is not limited thereto. The body B may include a mold portion 450 and a cover portion 460. The cover portion 460 may be disposed on the mold portion 450 with reference to FIG. 16, to surround all surfaces of the mold portion 450 except for a lower surface thereof. Therefore, the first to fifth surfaces 401, 402, 403, 404, and 405 of the body B may be formed by the cover portion 460, and the sixth surface 406 of the body B may be formed by the mold portion 450 and the cover portion 460. The mold portion 450 may have one surface and the other surface, opposing each other. The one surface of the mold portion 450 may be a surface corresponding to the lower surface of the mold portion 450, and refers to a region in which accommodating grooves h1 and h2 to be described later are disposed. As will be described later, since the accommodating grooves h1 and h2 are processed in the mold portion 450, lower surfaces of the accommodating grooves h1 and h2 may be disposed in a region between the one surface and the other surface of the mold portion 450. The mold portion 450 may include a support portion 410 and a core 420. The core 420 may pass through the coil portion 430, to be disposed in a central portion of the other surface of the support portion 410. For the above reasons, in the present specification, the one surface and the other surface of the mold portion 450 may be used in the same meaning as one surface and the other surface of the support portion 410, respectively. The mold portion 450 may be formed by filling a mold with a composite material including the magnetic particles 321, 322, and 323 of FIG. 13 and an insulating resin. In this case, the insulating resin may include, but is not limited to, epoxy, polyimide, a liquid crystal polymer, or the like, alone or in combination.

The coil portion 430 may be embedded in the body B, to express characteristics of the magnetic component 400. For example, when the magnetic component 400 of the present embodiment is used as a power inductor, the coil portion 430 may play a role for storing an electric field as a magnetic field to maintain an output voltage, to stabilize power of an electronic device. The coil portion 430 may be disposed on the other surface of the mold portion 450. Specifically, the coil portion 430 may be wound around the core 420, and may be disposed on the other surface of the support portion 410. The coil portion 430 may be an air-core coil, and may be configured as a flat coil. The coil portion 430 may be formed by winding a metal wire such as a copper wire or the like of which surface is coated with an insulating material in a spiral shape. The coil portion 430 may be comprised of a plurality of layers. Each of the layers of the coil portion 430 may be formed to have a planar spiral shape, and may have a plurality of turns. For example, the coil portion 430 may form an innermost turn T1, at least one intermediate turn T2, and an outermost turn T3, from a central portion of one surface of the mold portion 450 in an outward direction.

The cover portion 460 may be disposed on the mold portion 450 and the coil portion 430. The cover portion 460 may cover the mold portion 450 and the coil portion 430. The cover portion 460 may be disposed on the support portion 410 and the core 420 of the mold portion 450, and the coil portion 430, and then pressurized to be coupled to the mold portion 450. At least one of the mold portion 450 or the cover portion 460 may include the magnetic particles 321, 322, and 323 of FIG. 13, and in the present embodiment, each of the mold portion 450 and the cover portion 460 may include the magnetic powers (particles) 321, 322, and 323 of FIG. 13.

First and second accommodating grooves h1 and h2 may be formed on one surface of the mold portion 450 to be spaced apart from each other, and the first and second accommodating grooves h1 and h2 may have both end portions of the coil portion 430 to be described later. For example, the first and second accommodating grooves h1 and h2 may be respectively formed on the one surface of the mold portion 450, and may be spaced apart from each other in a longitudinal direction X. The first and second accommodating grooves h1 and h2 may be disposed outside a region corresponding to the core 420, on the one surface of the mold portion 450, but the present disclosure is not limited thereto. Each of the first and second accommodating grooves h1 and h2 may be formed to extend in one direction from the one surface of the mold portion 450, but may be formed in a non-limited form, when having a structure that may effectively expose both end portions of the coil portion 430.

Since the body B may be a region including the mold portion 450 and the cover portion 460, one surface of the body B means one surface of the region including the mold portion 450 and the cover portion 460. The coil portion 430 may be drawn out externally, and may include first and second lead-out portions disposed in the first and second accommodating grooves h1 and h2, respectively. The first and second accommodating grooves h1 and h2 may be regions in which both end portions of the coil portion 430 are drawn out to the external electrodes 470 and 480, and may thus formed on one surface of the body B to be spaced apart from each other to correspond to the first and second external electrodes 470 and 480, respectively.

As an example, through-grooves H1 and H2 may be formed by a mold in forming the mold portion 450, and first and second accommodating grooves h1 and h2 may be formed on the mold portion 450 in a process of forming the cover portion 460 by laminating and pressing a magnetic sheet including a magnetic metal particle. In the mold for forming the mold portion 450, protrusions corresponding to the through-grooves H1 and H2 may be formed, and the through-grooves H1 and H2 may be formed in the mold portion 450 manufactured to have a shape corresponding to a shape of the mold. Also, the first and second accommodating grooves h1 and h2 may not be formed in a process of forming the mold portion 450, but may be formed in a process of forming the cover portion 460 on the mold portion 450. For example, both end portions of the coil portion 300 protruding from the one surface of the mold portion 450 through the through-grooves H1 and H2 of the mold portion 450 may be embedded in the mold portion 450 in a process of pressing the magnetic sheet. Therefore, the first and second accommodating grooves h1 and h2 may be formed on the one surface of the mold portion 450.

Alternatively, the first and second accommodating grooves h1 and h2 and the through-grooves H1 and H2 may be formed in the process of forming the mold portion 450 using a mold. In this case, protrusions corresponding to the first and second accommodating grooves h1 and h2 and the through-grooves H1 and H2 may be formed in the mold used to form the mold portion 450.

Both end portions of the coil portion 430 may pass through the one surface of the mold portion 450, to be disposed in the first and second accommodating grooves h1 and h2, respectively. Since a shape in which an end portion of the coil portion 430 is disposed in the accommodating grooves h1 and h2 may not be limited, widths of the first and second accommodating grooves h1 and h2 may be equal to or different from widths of the through-grooves H1 and H2. Both end portions of the coil portion 430 may be exposed from the one surface of the mold portion 450, e.g., the sixth surface 406 of the body B. Both end portions of the coil portion 430 exposed from the one surface of the mold portion 450 may be disposed in the first and second accommodating grooves h1 and h2 formed to be spaced apart from each other on the sixth surface 406 of the body B. Both end portions of the coil portion 430 may pass through the support portion 410 of the mold portion 450, and be exposed from one surface of the support portion 410. Although not specifically illustrated, since both end portions of the coil portion 430 have a thickness, equal to a thickness of the coil portion 430, the coil portion 430 may have a shape protruding from the one surface of the support portion 410 by an amount corresponding to the thickness of the coil portion 430. Since the protruding end portion may also be polished, in a process of polishing an opening of a plating resist for forming the external electrodes 470 and 480 to be described later, an end portion of the coil portion 430 exposed from the one surface of the support portion 410 may be substantially smaller than the thickness of the coil portion 430.

The external electrodes 470 and 480 may be spaced apart from each other on one surface of the body B, e.g., the sixth surface 406. Specifically, the external electrodes 470 and 480 may be disposed on one surface of the mold portion 450 to be spaced apart from each other, respectively, and may be connected to both end portions of the coil portion 430 disposed in the first and second accommodating grooves h1 and h2, respectively. Both end portions of the coil portion 430 may be disposed along lower surfaces of the first and second accommodating grooves h1 and h2, and the external electrodes 470 and 480 may be applied along both end portions of the coil portion 430, such that the external electrodes may be formed to correspond to shapes of the first and second accommodating grooves h1 and h2. As an example, the external electrodes 470 and 480 may be formed by coating a conductive resin including a conductive particle such as silver (Ag) on the first and second accommodating grooves h1 and h2. The external electrodes 470 and 480 may be formed of a conductive material such as copper (Cu), aluminum (Al), silver (Ag), tin (Sn), gold (Au), nickel (Ni), lead (Pb), chromium (Cr), titanium (Ti), or alloys thereof, but the present disclosure is not limited thereto. The external electrodes 470 and 480 may be formed in a single-layer structure or a multilayer structure. According to the present embodiment, the external electrodes 470 and 480 may include a first layer contacting and connected to both end portions of the coil portion 430, and a second layer covering the first layer. As an example, the first layer may be formed of a conductive resin including silver (Ag) particle, but the present disclosure is not limited thereto, and may be formed of a plating layer including copper (Cu). Although not specifically illustrated, the second layer may be disposed on the first layer to cover the first layer. The second layer may include nickel (Ni) and/or tin (Sn). The second layer may be formed by electroplating, but the present disclosure is not limited thereto.

The magnetic component 400 according to the present embodiment may further include an insulating layer 490 surrounding a surface of the coil portion 430. A process of forming the insulating layer 490 is not limited, but may be formed by, for example, chemical vapor deposition of parylene resin or the like on the surface of the coil portion 430, and may be formed by a known method such as screen printing method, photoresist (PR) exposure, a process through development, spray application, dipping process, or the like. The insulating layer 490 is not particularly limited as long as it may be formed as a thin film, but may include, for example, photoresist (PR), an epoxy-based resin, or the like.

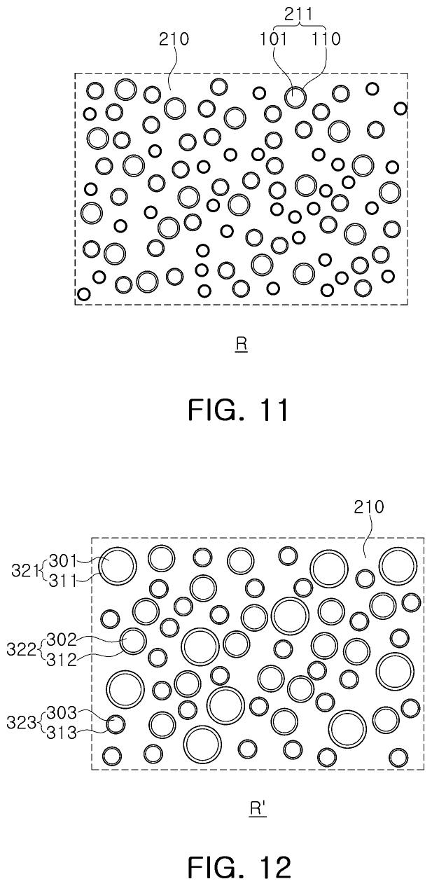

Although not illustrated, the magnetic component 400 according to the present embodiment further may include an additional insulating layer in a region of the sixth surface 406 of the body B, except for a region in which the external electrodes 470 and 480 are disposed. The additional insulating layer may be used as a plating resist in forming the external electrodes 470 and 480 by electroplating, but the present disclosure is not limited thereto. In addition, the additional insulating layer may be disposed on at least a portion of the first to fifth surfaces 401, 402, 403, 404, and 405 of the body B, to prevent an electrical short circuit between other electronic components and the external electrodes 470 and 480. Although it is illustrated that the through-grooves H1 and H2 pass through the mold portion 450 in the mold portion 450, this is merely illustrative. For example, as a modified embodiment of the present embodiment, the through-grooves H1 and H2 may be formed on a side surface of the mold portion 450, and may communicate with the first and second accommodating grooves h1 and h2, disposed on one surface of the mold portion 450. In this case, both end portions of the coil portion 430 may be disposed along the side surface of the mold portion 450 and the one surface of the mold portion 450. In addition, although the magnetic component 400 includes the magnetic particle of FIG. 13 in the present embodiment, the magnetic component 400 may also include the magnetic particle of FIG. 11, and this may be applied to the following embodiments in a similar manner.

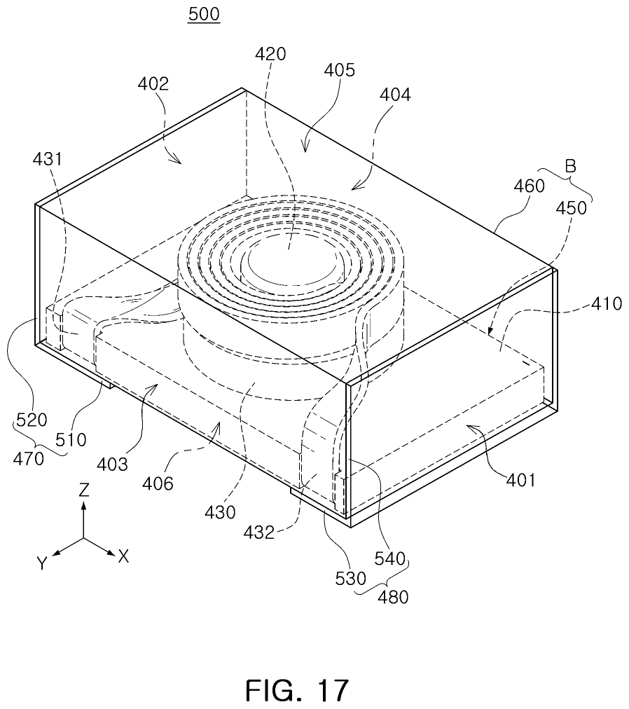

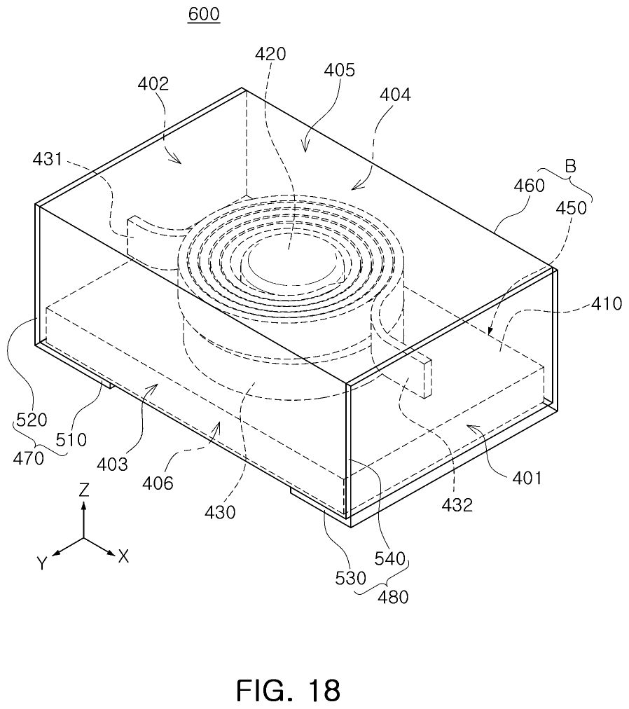

Magnetic components according to the modified embodiment will be described with reference to FIGS. 17 and 18. First, in an embodiment of FIG. 17, a magnetic component 500 may be different from the previous embodiment in view of a manner in which a coil portion 430 is drawn out of a body B, and other overlapping configurations will be omitted. In the present embodiment, a support portion 410 of the magnetic component 500 may include first and second accommodating grooves h1 and h2 formed to have shapes corresponding to shapes of first and second lead-out portions 431 and 432, to accommodate the first and second lead-out portions 431 and 432 of a winding coil 430. The first and second accommodating grooves h1 and h2 may be respectively formed in a thickness direction (a T direction) on one side surface of the support portion 410, and may be formed to extend from the other surface (406) of the support portion 410 in a second direction (a Y-direction). The first and second accommodating grooves h1 and h2 may be disposed parallel to each other in a first direction (an X-direction). Therefore, when a magnetic material is included in a cover portion 460, a component, identical to the magnetic material of the cover portion 460, may be disposed in the first and second accommodating grooves h1 and h2. The first and second lead-out portions 431 and 432 may be accommodated along the first and second accommodating grooves h1 and h2 of the support portion 410, respectively, and one end thereof may be connected to the winding part, and the other end thereof may be exposed from a sixth surface 406 of the body B and may be respectively connected to first and second external electrodes 470 and 480. In this case, the first external electrode 470 may include a region 510 covering the sixth surface 406 of the body B and a region 520 covering a second surface 402 of the body B. The second external electrode 480 may include a region 530 covering the sixth surface 406 of the body B and a region 540 covering the first surface 401.

Next, in an embodiment of FIG. 18, a separate accommodating groove may not be formed in a support portion 410 of a magnetic component 600. Therefore, first and second lead-out portions 431 and 432 of a winding coil 430 may be exposed from an opposite side surface of a body B, respectively. For example, the first lead-out portion 431 may be exposed from a first surface 401 of the body B, and the second lead-out portion 432 may be exposed from a second surface 402 of the body B, to be connected to first and second external electrodes 470 and 480, respectively.

In a magnetic particle according to an embodiment of the present disclosure, coercive force may be effectively reduced, and thus loss of a magnetic component employing the same may be reduced to increase efficiency.

While example embodiments have been illustrated and described above, it will be apparent to those skilled in the art that modifications and variations could be made without departing from the scope of the present disclosure as defined by the appended claims.

What is claimed is:

1. A magnetic particle comprising:
a magnetic metal particle; and
an oxide film disposed on a surface of the magnetic metal particle,
wherein the magnetic metal particle includes a single crystalline zone containing a first Fe component, and
the oxide film includes an amorphous zone containing a second Fe component.

2. The magnetic particle of claim 1, wherein the magnetic metal particle consists of the single crystalline zone.

3. The magnetic particle of claim 1, wherein the magnetic metal particle is free of an amorphous zone.

4. The magnetic particle of claim 1, wherein an area ratio of the single crystalline zone in a cross-section of the magnetic metal particle is 30% or more.

5. The magnetic particle of claim 1, wherein the single crystalline zone comprises an Fe-Si-Cr-based alloy.

6. The magnetic particle of claim 1, wherein the single crystalline zone comprises an α-Fe phase.

7. The magnetic particle of claim 6, wherein the α-Fe phase comprises at least one selected from the group consisting of an Fe(001) phase, an Fe(002) phase, an Fe(011) phase, an Fe(101) phase, and an Fe(111) phase.

8. The magnetic particle of claim 1, wherein the amorphous zone of the oxide film comprises an Fe-based metal oxide.

9. The magnetic particle of claim 1, wherein the oxide film further comprises a crystalline zone.

10. The magnetic particle of claim 9, wherein an area ratio of the amorphous zone in a cross-section of the oxide film is 30% or more.

11. The magnetic particle of claim 1, wherein a thickness of the oxide film is 5 to 20 nm.

12. The magnetic particle of claim 1, wherein the magnetic particle has a diameter of 10 to 900 nm.

13. A magnetic component comprising:
a body including a plurality of magnetic particles,
wherein at least one magnetic particle, among the plurality of magnetic particles, includes a magnetic metal particle including a first Fe component and an oxide film disposed on a surface of the magnetic metal particle, and
wherein the magnetic metal particle includes a single crystalline zone containing the first Fe component, and
the oxide film includes an amorphous zone containing a second Fe component.

14. The magnetic component of claim 13, further comprising a coil disposed in the body.

15. The magnetic component of claim 13, wherein, the at least one magnetic particle including the single crystalline zone is referred to as a single crystal particle,
a plurality of single crystal particles are present in the body, and
D50 of a diameter of each of the plurality of single crystal particles is 100 to 300 nm.

16. A magnetic component comprising:
a body including a plurality of magnetic particles,
wherein the plurality of magnetic particles include first to third magnetic particles including first to third magnetic metal particles, respectively,
wherein the first magnetic particle has a diameter in a first diameter range, the second magnetic particle has a diameter in a second diameter range, smaller than the first diameter range, and the third magnetic particle has a diameter in a third diameter range, smaller than the second diameter range,
wherein the third magnetic metal particle includes a single crystalline zone containing a first Fe component.

17. The magnetic component of claim 16, wherein the diameters of the first to third magnetic particles are diameters measured in a cross-section of the body.

18. The magnetic component of claim 17, wherein the first diameter range is 5 to 61 μm,
the second diameter range is 0.6 to 4.5 μm, and
the third diameter range is 10 to 900 nm.

19. The magnetic component of claim 18, wherein the second and third magnetic metal particles comprise different materials.

20. The magnetic component of claim 18, wherein, in the cross-section of the body, relative to a sum of areas of the first to third magnetic particles, an area ratio of the first magnetic particle is 50 to 90%, and an area ratio of the third magnetic particle is 7.6 to 16%.

21. The magnetic component of claim 17, wherein the first diameter range is 5 to 61 μm,
the second diameter range is 0.9 to 4.5 μm, and
the third diameter range is 10 to 800 nm.

22. The magnetic component of claim 16, wherein the first to third magnetic particles further comprise first to third oxide films respectively disposed on surfaces of the first to third magnetic metal particles,
wherein the third oxide film includes an amorphous zone including a second Fe component.

23. A composition comprising:
a first magnetic particle having a diameter in a first diameter range,
a second magnetic particle having a diameter in a second diameter range, smaller than the first diameter range, and
a third magnetic particle having a diameter in a third diameter range, smaller than the second diameter range, the third magnetic particle including a third magnetic metal particle that includes a single crystalline zone containing a first Fe component and a third oxide film disposed on a surface of the third magnetic metal particle, the third oxide film including an amorphous zone including a second Fe component.

24. The composition of claim 23, wherein the third magnetic metal particle consists of the single crystalline zone.

25. The composition of claim 24, wherein the single crystalline zone comprises an Fe-Si-Cr-based alloy.

26. The composition of claim 24, wherein the single crystalline zone comprises an α-Fe phase.

27. The composition of claim 26, wherein the α-Fe phase comprises an Fe(011) phase.

28. The composition of claim 23, further comprising an insulating material including at least one of an epoxy resin, polyimide, and a liquid crystal polymer.

29. The composition of claim 23, wherein the first magnetic particle includes a first magnetic metal particle and a first oxide film disposed on a surface of the first magnetic metal particle,
the second magnetic particle includes a second magnetic metal particle and a second oxide film disposed on a surface of the second magnetic metal particle.

30. The composition of claim 29, wherein the first to third magnetic metal particles each independently includes at least one of pure iron, an Fe-Si-based alloy, an Fe-Si-Al-based alloy, an Fe-Ni-based alloy, an Fe-Ni-Mo-based alloy, an Fe-Ni-Mo-Cu-based alloy, an Fe-Co-based alloy, an Fe-Ni-Co-based alloy, an Fe-Cr-based alloy, an Fe-Cr-Si-based alloy, an Fe-Si-Cu-Nb-based alloy, an Fe-Ni-Cr-based alloy, and an Fe-Cr-Al-based alloy.

31. The composition of claim 30, wherein the first to third oxide films each independently includes Fe₂O₃, Fe₃O₄ or both.

32. A magnetic component comprising:
a body including first to third magnetic particles,
the first magnetic particle having a diameter in a first diameter range,
the second magnetic particle having a diameter in a second diameter range, smaller than the first diameter range, and
the third magnetic particle having a diameter in a third diameter range, smaller than the second diameter range, the third magnetic particle including a third magnetic metal particle that includes a single crystalline zone containing a first Fe component and a third oxide film disposed on a surface of the third magnetic metal particle, the third oxide film including an amorphous zone including a second Fe component.

33. The magnetic component of claim 32, wherein the body includes a laminate including a plurality of layers including the first to third magnetic particles.

34. The magnetic component of claim 32, wherein, in a cross-section of the body, relative to a sum of areas of the first to third magnetic particles, an area ratio of the first magnetic particle is 50 to 90%, and an area ratio of the third magnetic particle is 7.6 to 16%.

35. The magnetic component of claim 32, further comprising a coil disposed within the body, a support member supporting the coil, a through-hole is disposed in a central portion of the support member, and an external electrode disposed on a surface of the body to be electrically connected to the coil.

36. The magnetic component of claim 32, further comprising a coil portion embedded in the body, an external electrode disposed on a surface of the body to be electrically connected to the coil portion, wherein the body includes a mold portion including a core that passes through the coil portion.

37. The magnetic component of claim 36, wherein the body further includes a cover portion disposed on the mold portion, and the cover portion surrounds all surfaces of the mold portion except for a lower surface of the mold portion.

38. The magnetic component of claim 37, further comprising an accommodating groove disposed in the mold portion.

39. The magnetic component of claim 38, wherein the coil portion includes an end portion disposed in the accommodating groove.
